(19) United States
(12) Patent Application Publication
(10) Pub. No.: US 2026/0112647 A1
(43) Pub. Date: Apr. 23, 2026

(54) NEGATIVE ELECTRODE FOR ALL-SOLID-STATE BATTERY, ALL-SOLID-STATE BATTERY INCLUDING THE SAME, AND METHOD OF MANUFACTURING THE SAME

(71) Applicant: Samsung SDI Co., Ltd., Yongin-si (KR)

(72) Inventors: Yunsik KIM, Yongin-si (KR); JOONGHO MOON, Yongin-si (KR); CHUL YOUM, Yongin-si (KR); Eunjoo LEE, Yongin-si (KR); Jinhee IM, Yongin-si (KR); JUNGHO LEE, Yongin-si (KR); Juhee SOHN, Yongin-si (KR); Haena YIM, Yongin-si (KR); Seungman PARK, Yongin-si (KR); Jinhoon YANG, Yongin-si (KR)

(21) Appl. No.: 19/362,721

(22) Filed: Oct. 20, 2025

(30) Foreign Application Priority Data
Oct. 22, 2024 (KR) 10-2024-0144742

(51) Int. Cl. H01M 4/62; H01M 4/02; H01M 4/04; H01M 4/133; H01M 4/1393; H01M 4/36; H01M 4/38; H01M 4/587

(52) U.S. Cl. CPC H01M 4/628; H01M 4/0404; H01M 4/0428; H01M 4/133; H01M 4/1393; H01M 4/366; H01M 4/386; H01M 4/587; H01M 2004/021; H01M 2004/027

(57) ABSTRACT

Disclosed are negative electrodes for all-solid-state batteries, all-solid-state batteries including the same, and methods of manufacturing negative electrodes for all-solid-state batteries. The negative electrode comprises a negative electrode current collector and a negative electrode active material layer. The negative electrode active material layer comprises a negative electrode active material and a solid electrolyte. The negative electrode active material includes a porous support and silicon (Si). The silicon fills at least a portion of a pore of the porous support.

### CROSS-REFERENCE TO RELATED APPLICATION

The present application claims priority to and the benefit of Korean Patent Application No. 10-2024-0144742, filed on Oct. 22, 2024, in the Korean Intellectual Property Office, the entire content of which is hereby incorporated by reference.

### BACKGROUND

Embodiments of the present disclosure relate to a negative electrode for an all-solid-state battery, an all-solid-state battery including the same, and a method of manufacturing the same.

There has recently been active development of high-energy density and safe batteries driven by industrial demands. For example, lithium ion batteries are being commercialized not only in formation-related and communication devices but also in the automotive industry. In the automotive industry, safety is particularly emphasized due to its direct relation to human lives.

There has recently been suggested an all-solid-state battery that uses a solid electrolyte in place of a liquid electrolyte. As an all-solid-state battery does not use a flammable organic dispersion medium, the possibility of fire or explosion may be significantly reduced even in the event of short-circuit. Accordingly, an all-solid-state battery may significantly increase safety as compared to a lithium ion battery using a liquid electrolyte.

### SUMMARY

An embodiment of the present disclosure provides a negative electrode for an all-solid-state battery having excellent electrical conductivity, superior ionic conductivity, and improved lifespan characteristics.

An embodiment of the present disclosure provides a method of manufacturing a negative electrode for an all-solid-state battery having excellent electrical conductivity and superior ionic conductivity.

According to an embodiment of the present disclosure, a negative electrode for an all-solid-state battery may include: a negative electrode current collector; and a negative electrode active material layer. The negative electrode active material layer may include a negative electrode active material and a solid electrolyte. The negative electrode active material may include a porous support and silicon (Si). The silicon may fill at least a portion of a pore of the porous support.

According to an embodiment of the present disclosure, an all-solid-state battery may include: the negative electrode discussed above; a positive electrode; and a solid electrolyte layer between the negative electrode and the positive electrode.

According to an embodiment of the present disclosure, a method of manufacturing a negative electrode for an all-solid-state battery may include: preparing a negative electrode active material; mixing the negative electrode active material and a solid electrolyte to prepare a negative electrode active material slurry; and coating the negative electrode active material slurry on a negative electrode current collector. The preparing the negative electrode active material may include: preparing a porous support; and allowing the porous support to undergo a vapor deposition process to form a silicon nano-particle.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a cross-sectional view showing an all-solid-state battery according to an embodiment of the present disclosure.

FIG. 2 is a cross-sectional view showing an all-solid-state battery according to an embodiment of the present disclosure.

FIG. 3 is a plan view showing an all-solid-state battery according to an embodiment of the present disclosure.

FIG. 4 is a cross-sectional view showing an all-solid-state battery according to an embodiment of the present disclosure.

FIG. 5 is an enlarged view showing section M of FIG. 1.

FIG. 6 is an enlarged view showing a negative electrode active material according to an embodiment of the present disclosure.

FIG. 7 is a graph showing an X-ray diffraction analysis of a porous support and a negative electrode active material according to an embodiment of the present disclosure.

FIG. 8 is a curved graph showing N₂ gas adsorption/desorption of a porous support according to an embodiment of the present disclosure.

FIG. 9 is a graph showing pore distribution of a porous support according to an embodiment of the present disclosure.

FIG. 10 is a surface SEM image and an EDX mapping image showing a negative electrode active material according to an embodiment of the present disclosure.

### DETAILED DESCRIPTION

In order to sufficiently understand the configuration and effect of the subject matter of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components may be exaggerated effectively explain the technical contents of the present disclosure. Like reference numerals refer to like elements throughout the specification.

Some embodiments detailed in this description will be discussed with reference to sectional and/or plan views as idealized example views of the present disclosure. In the drawings, thicknesses of layers and regions may be exaggerated to effectively explain the technical contents of the present disclosure. Accordingly, regions illustrated as examples in the drawings have general properties, and shapes of regions illustrated as examples in the drawings are used to disclose examples of set or specific shapes but not to limit the scope of the present disclosure. It will be understood that, although the terms “first”, “second”, “third”, etc. may be used herein to describe various elements, these elements should not be limited by these terms.

These terms are only used to distinguish one element from another element. The example embodiments explained and illustrated herein include complementary embodiments thereof.

The terms in this description are merely used to describe various embodiments, but are not intended to limit the present disclosure. Unless otherwise specially noted in this description, the expression of singular form may include the expression of plural form. The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

In this description, each of phrases as “A or B,” “at least one of A and B,” “at least one of A or B,” “A, B, or C,” “at least one of A, B, and C,” and “at least one of A, B, or C,” may include any one of, or all possible combinations of, the items enumerated together in a corresponding one of the phrases.

Unless otherwise especially defined in this description, a particle diameter may be an average particle diameter. In embodiments, a particle diameter indicates an average particle diameter (D₅₀) of particles having a cumulative volume of about 50 vol % in particle size distribution. The average particle diameter (D₅₀) may be measured by any suitable method generally used in the art, for example, by a particle size analyzer, a transmission electron microscope (TEM) image, and/or a scanning electron microscope (SEM) image. In embodiments, a dynamic light-scattering measurement device is used to perform a data analysis, the number of particles is counted for each particle size range, and then from this, an average particle diameter (D₅₀) value may be obtained through a calculation. In embodiments, a laser scattering method may be utilized to measure the average particle diameter (D₅₀). In the laser scattering method, a target particle may be dispersed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) may be calculated in the 50% standard of particle diameter distribution in the measurement device.

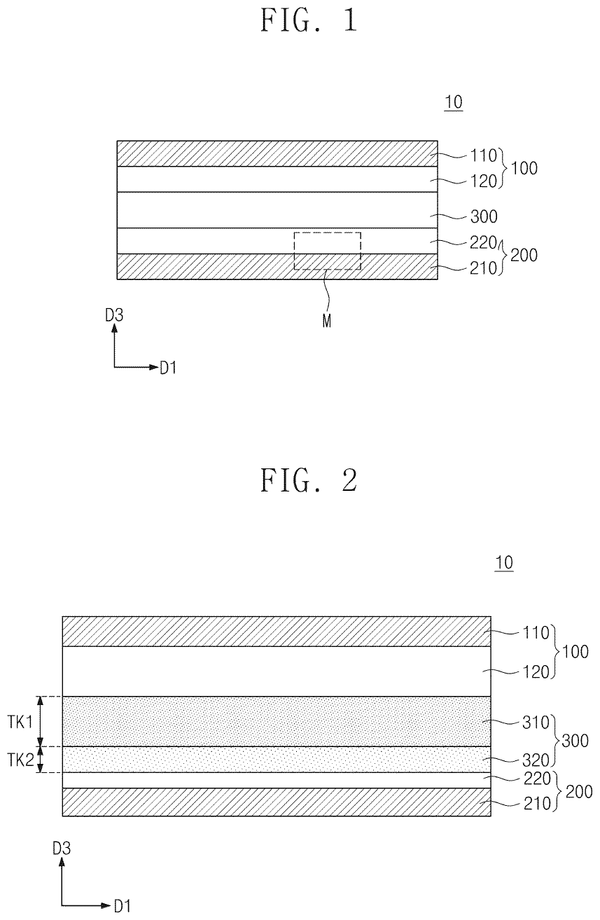

FIG. 1 illustrates a cross-sectional view showing an all-solid-state battery 10 according to an embodiment of the present disclosure.

Referring to FIG. 1, the all-solid-state battery 10 may include a positive electrode layer 100, a negative electrode layer 200 opposite to the positive electrode layer 100, and a solid electrolyte layer 300 between the positive electrode layer 100 and the negative electrode layer 200. The present disclosure, however, is not limited thereto, and the all-solid-state battery 10 may further include an additional functional layer, such as an adhesion enhancement layer, between the positive electrode layer 100 and the solid electrolyte layer 300 and/or between the negative electrode layer 200 and the solid electrolyte layer 300.

The positive electrode layer 100 according to an embodiment may include a positive electrode current collector 110 and a positive electrode active material layer 120 on the positive electrode current collector 110. The positive electrode active material layer 120 may include a positive electrode active material, a solid electrolyte, a conductive material (e.g., an electrically conductive material), and a binder.

The positive electrode current collector 110 may provide a reference surface on which the positive electrode active material layer 120 is provided. The positive electrode current collector 110 may include a plate and/or foil including, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof.

Differently from that shown in FIG. 1, in an embodiment of the present disclosure, the positive electrode current collector 110 may not be provided. In embodiments, in order to increase adhesion between the positive electrode current collector 110 and the positive electrode active material layer 120, a carbon layer having a thickness of about 0.1 μm to about 4 μm may further be between the positive electrode current collector 110 and the positive electrode active material layer 120.

The positive electrode active material layer 120 may include a positive electrode active material, a solid electrolyte, a conductive material (e.g., an electrically conductive material), and a binder.

The positive electrode active material may be a material that can reversibly absorb and desorb lithium ions. For example, the positive electrode active material may include lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and/or lithium iron phosphate), nickel sulfide, copper sulfide, lithium sulfide, iron oxide, and/or vanadium oxide, but the present disclosure is not limited thereto. The positive electrode active material may be used alone or in a mixture of two or more substances.

The lithium transition metal oxide may be, for example, a compound represented by one of LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}Dₐ(where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}Dₐ (where 0.90≤a≤1, 0≤b≤0.5, 0≤c≤0.05, and 0<α<2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄. In the compounds above, “A” may be Ni, Co, Mn, or a combination thereof, “B” may be Al, Ni, Co, Mn, Cr, Fe, Mg, Sr, V, a rare-earth element, or a combination thereof, “D” may be O, F, S, P, or a combination thereof, “E” may be Co, Mn, or a combination thereof, “F” may be F, S, P, or a combination thereof, “G” may be Al, Cr, Mn, Fe, Mg, La, Ce, Sr, V, or a combination thereof, “Q” may be Ti, Mo, Mn, or a combination thereof, “I” may be Cr, V, Fe, Sc, Y, or a combination thereof, and “J” may be V, Cr, Mn, Co, Ni, Cu, or a combination thereof.

The positive electrode active material may include, for example, lithium salt of transition metal oxide having a layered rock salt type structure (e.g., a layered rock salt kind of structure) among lithium transition metal oxides discussed above. The term “layered rock salt type structure” may refer to a structure in which an oxygen atom layer and a metal atom layer are alternately and regularly provided in a <111> direction of a cubic rock salt type structure (e.g., a cubic rock salt kind of structure), where each atom layer forms a two-dimensional plane. The term “cubic rock salt type structure” may refer to a sodium chloride (NaCl) type (e.g., kind of) structure, which is a type (e.g., kind) of crystal structure, and for example, has a structure in which face centered cubic lattices (FCCs) each formed of cations and anions are provided displaced from each other by ½ of a ridge of a unit lattice. The lithium transition metal oxide having the layered rock salt type structure may be a ternary lithium transition metal oxide, such as LiNiₓCo_{y}Al_{z}O₂ (NCA) and/or LiNiₓCo_{y}Mn_{z}O₂ (NCM) (where 0<x<1, 0<y<1, 0<z<1, and x+y+z=1). If (e.g., when) the positive electrode active material includes a ternary lithium transition metal oxide having the layered rock salt type structure, the all-solid-state battery 10 may have increased energy density and improved thermal stability.

The compound included in the positive electrode active material may be covered by a coating layer. The positive electrode active material may be used in a mixture of the compound and a compound to which the coating layer is added. The coating layer added to a surface of the positive electrode active material may include, for example, oxide, hydroxide, oxyhydroxide, oxycarbonate, and/or hydrocarbonate of a coating element discussed below. The compound that constitutes the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may include, for example, Li₂O—ZrO₂ (LZO). A method for forming the coating layer may be selected within any suitable methods that do not adversely affect physical characteristics of the positive electrode active material. The method of forming the coating layer may include, for example, spray coating and/or immersion.

If (e.g., when) the positive electrode active material includes nickel (Ni) as a ternary lithium transition metal oxide such as NCA and/or NCM, a capacity density of the all-solid-state battery 10 may increase to reduce metal elution from the positive electrode active material in a charged state. Therefore, the all-solid-state battery 10 may improve in cycle characteristics in a charged state. The language “cycle characteristics” may refer to properties that indicate the degree to which the all-solid-state battery 10 is degraded due to charge and discharge. For example, the all-solid-state battery 10 having high cycle characteristics may degrade less due to charge and discharge, while the all-solid-state battery 10 having low cycle characteristics may degrade more due to charge and discharge.

The positive electrode active material may have, for example, a spherical or oval (e.g. a generally spherical or oval) particle shape. There is no limitation on a particle diameter and an amount of the positive electrode active material.

The solid electrolyte may have a particle shape. The solid electrolyte may be dispersed between the positive electrode active materials. The solid electrolyte may include a sulfide-based solid electrolyte having excellent lithium ionic conductivity. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one selected from Ge, Zn, and Ga), Li₂S—GeS₂, Li₂S—SiS₂—Li₃PO₄, Li₂S—SiS₂-LiₚMO_{q} (where p and q are each a positive integer, and “M” is one selected from P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one selected from Li₆PS₅Cl, Li₆PS₅Br, and Li₆PS₅I.

In embodiments, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (TI), silicon (Si), germanium (Ge), tin (Sn), lead (Pb), arsenic (As), antimony (Sb), bismuth (Bi), or a combination thereof.

In embodiments, the solid electrolyte may be the same as that included in the solid electrolyte layer 300 which will be further discussed below.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance (e.g., electrical resistance) of an all-solid-state battery and to prevent a solid electrolyte layer from short-circuit and penetration caused by the formation of lithium dendrites (or reduced a likelihood, occurrence, or degree thereof). The solid electrolyte may have an elastic modulus of, for example, about 15 GPa to about 35 GPa.

The solid electrolyte included in the positive electrode active material layer 120 may have a medium-sized average particle diameter (D₅₀) that is less than that of a solid electrolyte included in the solid electrolyte layer 300. For example, the medium-sized average particle diameter (D₅₀) of the solid electrolyte in the positive electrode active material layer 120 may be about equal to or less than about 90%, 80%, 70%, 60%, 50%, 40%, 30%, or 20% of the medium-sized average particle diameter (D₅₀) of a solid electrolyte included in the solid electrolyte layer 300. The medium-sized average particle diameter (D₅₀) may be a median diameter measured with a laser-type particle size distribution analyzer.

The positive electrode active material layer 120 may include a conductive material (e.g., an electrically conductive material). The conductive material may have conductivity (e.g., electrical conductivity) without causing a chemical change (e.g., an undesirable chemical change) of the all-solid-state battery 10 to increase conductivity (e.g., electrical conductivity) of the positive electrode active material and the solid electrolyte.

The conductive material may include a carbon-based material. The conductive material may include, for example, one or more selected from graphite, carbon black, acetylene black, carbon nano-fiber, and carbon nano-tube.

The positive electrode active material layer 120 may include a binder. The binder may include a material that adheres to each other the positive electrode active material, the solid electrolyte, and the conductive material included in the positive electrode active material layer 120 and that improves adhesion between the positive electrode active material layer 120 and the positive electrode current collector 110. The binder may include, for example, at least one selected from polyvinylidenefluoride, styrene-butadiene rubber (SBR), polytetrafluoroethylene, vinylidenefluoride/hexafluoropropylene copolymer, polyvinylidenefluoride/hexafluoropropylene copolymer, polyacrylonitrile, and polymethylmethacrylate.

Based on the total 100 parts by weight of the positive electrode active material, the solid electrolyte, the conductive material, and the binder, the positive electrode active material may be included in an amount of about 85 parts by weight to about 92 parts by weight in the positive electrode active material layer 120. Based on the total 100 parts by weight of the positive electrode active material, the solid electrolyte, the conductive material, and the binder, the binder may be included in an amount of about 0.5 parts by weight to about 1.5 parts by weight in the positive electrode active material layer 120.

Based on 100 parts by weight of the solid electrolyte, the conductive material may be included in an amount of about 1 part by weight to about 50 parts by weight in the positive electrode active material layer 120. If (e.g., when) the conductive material is included in an amount of less than about 1 part by weight relative to 100 parts by weight of the solid electrolyte, a proportion of the conductive material may decrease to reduce electrical conductivity of the positive electrode active material layer 120. If (e.g., when) the conductive material is included in an amount of greater than about 50 parts by weight relative to 100 parts by weight of the solid electrolyte, a proportion of the conductive material may excessively increase to cause incomplete formation of a coating layer that covers a surface of the solid electrolyte.

The positive electrode active material layer 120 may further include an additive, such as a filler, a coating agent, a dispersant, and an ionic conductivity agent, in addition to the positive electrode active material, the solid electrolyte, the conductive material, and the binder.

Referring still to FIG. 1, the negative electrode layer 200 may include a negative electrode current collector 210 and a negative electrode active material layer 220 on the negative electrode current collector 210. The negative electrode active material layer 220 may include a negative electrode active material and a solid electrolyte.

The negative electrode current collector 210 may provide a reference surface on which the negative electrode active material layer 220 is provided. The negative electrode current collector 210 may include a material that does not react with lithium, for example, a material that does not form an alloy or a compound with lithium.

The material included in the negative electrode current collector 210 may include, for example, copper (Cu), stainless steel, titanium (Ti), iron (Fe), cobalt (Co), and/or nickel (Ni), but the present disclosure is not limited thereto and any suitable material may be applicable as long as it is used as an electrode current collector. The negative electrode current collector 210 may have a thickness of about 1 μm to about 20 μm, for example, about 5 μm to about 15 μm, or about 7 μm to about 10 μm.

The negative electrode current collector 210 may be formed of one of the metals mentioned above, an alloy of two or more of the metals mentioned above, or a coating material. The negative electrode current collector 210 may have, for example, a plate and/or foil shape. In an embodiment, the negative electrode current collector 210 may not be provided.

The negative electrode active material layer 220 will be further discussed in more detail below with reference to FIGS. 4 and 5.

The solid electrolyte layer 300 may be provided between the positive electrode layer 100 and the negative electrode layer 200. The solid electrolyte layer 300 may include a sulfide-based solid electrolyte with excellent lithium ionic conductivity. The solid electrolyte included in the solid electrolyte layer 300 may be the same as or different from the solid electrolyte included in the positive electrode active material layer 120.

In an embodiment, the solid electrolyte included in the solid electrolyte layer 300 may be in an amorphous state, a crystalline state, or a mixed state thereof. The solid electrolyte may include at least sulfur (S), phosphorus (P), and lithium (Li) among component elements included in the sulfide-based solid electrolyte mentioned above.

For example, the solid electrolyte may be a material including Li₂S—P₂S₅. If (e.g., when) Li₂S—P₂S₅ is utilized as the sulfide-based solid electrolyte material of the solid electrolyte, a mixing molar ratio of Li₂S and P₂S₅ may be in a range of about 50:50 to about 90:10.

The sulfide-based solid electrolyte may be an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one selected from Li₆PS₅Cl, Li₆PS₅Br, and Li₆PS₅I.

In embodiments, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (AI), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance (e.g., electrical resistance) of an all-solid-state battery and to prevent a solid electrolyte layer from short-circuit and penetration caused by the formation of lithium dendrites (or reduce a likelihood, occurrence, or degree thereof). The first solid electrolyte may have a modulus of, for example, about 15 GPa to about 35 GPa.

The solid electrolyte layer 300 may further include a binder. The binder included in the solid electrolyte layer 300 may include, for example, styrene-butadiene rubber (SBR), polytetrafluoroethylene, polyvinylidenefluoride, and/or polyethylene, but the present disclosure is not limited thereto. For example, the binder may include at least one selected from styrene-butadiene rubber, polytetrafluoroethylene, polyvinylidenefluoride, polyethylene, polyvinylalcohol, vinylidenefluoride/hexafluoropropylene copolymer, polyvinylidenefluoride/hexafluoropropylene copolymer, polyacrylonitrile, and polymethylmethacrylate. The binder of the solid electrolyte layer 300 may be the same as or different from that of the positive electrode active material layer 120 or that of the negative electrode active material layer 220.

FIG. 2 is a cross-sectional view showing an all-solid-state battery 10 according to an embodiment of the present disclosure.

Referring to FIG. 2, the solid electrolyte layer 300 may include a first solid electrolyte layer 310 and a second solid electrolyte layer 320. The first solid electrolyte layer 310 may be adjacent to the positive electrode layer 100, and the second solid electrolyte layer 320 may be adjacent to the negative electrode layer 200.

The first solid electrolyte layer 310 and the second solid electrolyte layer 320 may have thicknesses different from each other. The first solid electrolyte layer 310 may have a first thickness TK1, and the second solid electrolyte layer 320 may have a second thickness TK2. The first thickness TK1 may be greater than the second thickness TK2. For example, the first thickness TK1 may be about 2 to 100 times (e.g., a multiple of 2 to 100 of) the second thickness TK2.

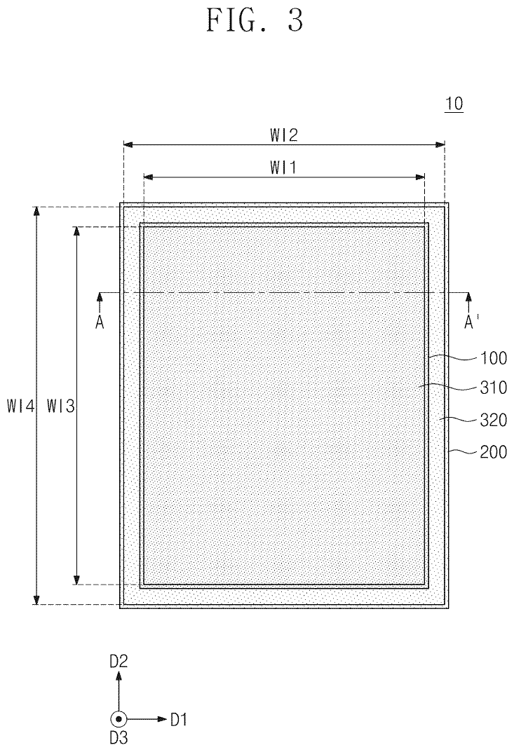

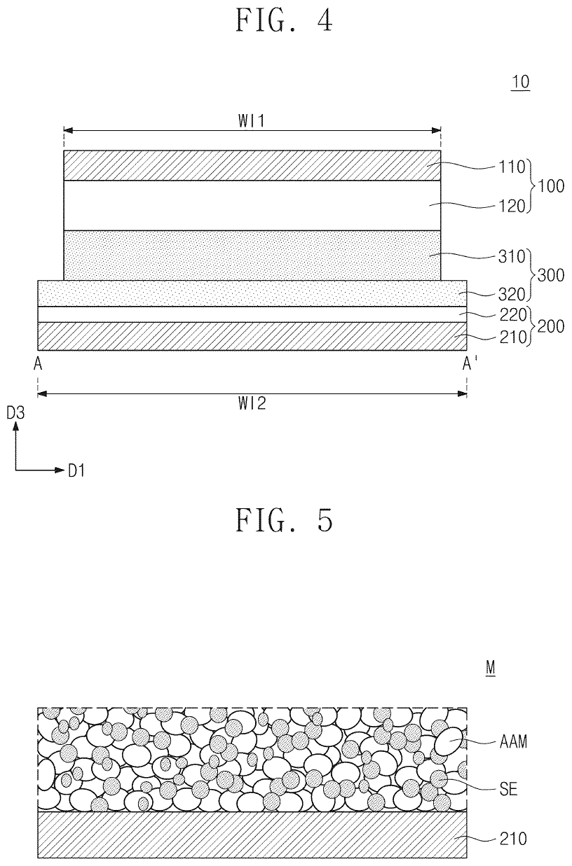

FIG. 3 is a plan view showing an all-solid-state battery 10 according to an embodiment of the present disclosure. FIG. 4 illustrates a cross-sectional view taken along line A-A′ of FIG. 3. In the embodiment that follows, a detailed description of technical features repetitive to those discussed above with reference to FIGS. 1 and 2 may not be repeated here, and a difference thereof will be discussed in more detail.

Referring to FIGS. 3 and 4, an area of the positive electrode layer 100 and an area of the negative electrode layer 200 may be different from each other. For example, the area of the negative electrode layer 200 may be greater than that of the positive electrode layer 100. The positive electrode layer 100 may completely inwardly overlap the negative electrode layer 200.

In an embodiment of the present disclosure, the first solid electrolyte layer 310 may have substantially the same area as that of the positive electrode layer 100. The second solid electrolyte layer 320 may have substantially the same area as that of the negative electrode layer 200.

For example, the first solid electrolyte layer 310 may have a first width WI1 in a first direction D1. The second solid electrolyte layer 320 may have a second width WI2 in the first direction D1. The first width WI1 may be less than the second width WI2. The first solid electrolyte layer 310 may have a third width WI3 in a second direction D2. The second solid electrolyte layer 320 may have a fourth width WI4 in the second direction D2. The third width WI3 may be less than the fourth width W14.

The all-solid-state battery 10 according to the present embodiment may be fabricated by forming a first stack of the positive electrode layer 100 and the first solid electrolyte layer 310, forming a second stack of the negative electrode layer 200 and the second solid electrolyte layer 320, and then laminating the first stack and the second stack.

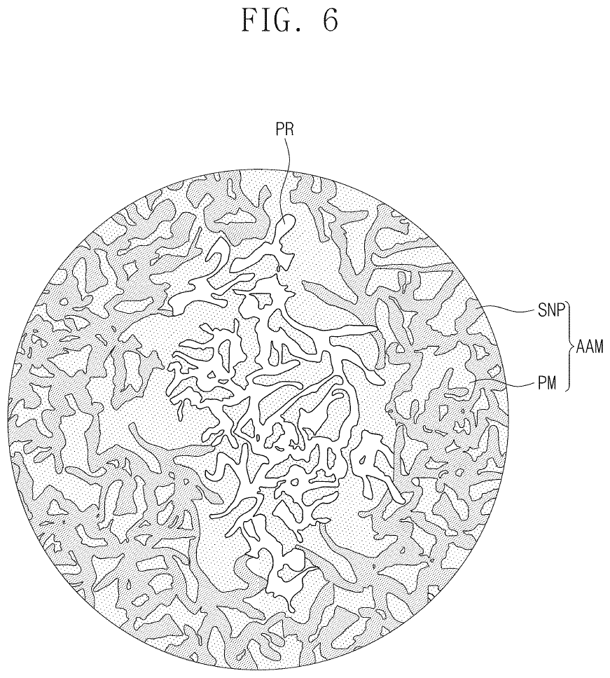

FIG. 5 illustrates an enlarged view of section M depicted in FIG. 5, showing a cross-section of a negative electrode for an all-solid-state battery according to an embodiment. FIG. 6 illustrates an enlarged view showing a negative electrode active material according to an embodiment.

Referring to FIGS. 5 and 6, the negative electrode active material layer 220 according to an embodiment may include a negative electrode active material AAM.

The negative electrode active material AAM may include a porous support PM and silicon SNP.

The silicon SNP may fill at least a portion of a pore PR in the porous support PM. A silicon particle may induce a volume expansion during charge, and this may become a primary cause of negative electrode deterioration. According to an embodiment of the present disclosure, as the silicon SNP fills the pore PR of the porous support PM, the volume expansion of silicon may be alleviated. For example, the porous support PM may alleviate (or suppress or reduce) the volume expansion of the silicon SNP to improve lifespan characteristics of an all-solid-state battery. In embodiments, the porous support PM may serve to control a particle size of the silicon SNP. A size and shape of the pore PR of the porous support PM may be controlled to adjust a size and shape of the silicon SNP formed in the pore PR.

The porous support PM may include, but is not particularly limited to, a material that can reversibly intercalate and deintercalate lithium ions, a lithium metal, a lithium metal alloy, a material that can dope and de-dope lithium, and/or a transition metal compound.

For example, the porous support PM may include a carbon-based material as the material that can reversibly intercalate and deintercalate lithium ions. The carbon-based material may include crystalline graphite and/or amorphous carbon, for example, amorphous hard carbon. Because hard carbon has almost no volume expansion during charge and discharge and exhibits excellent electrical conductivity and lithium ion mobility, if (e.g., when) the porous support PM includes hard carbon, it may be possible to suppress or reduce a volume expansion of silicon and to improve electrical conductivity and ionic conductivity.

According to an embodiment of the present disclosure, the porous support PM may include hard carbon which shows a peak at about 20° to about 26° in an XRD spectrum based on 2-theta. If (e.g., when) the porous support PM includes the hard carbon mentioned above, the negative electrode active material AAM may have superior ionic conductivity and excellent electrical conductivity.

According to an embodiment of the present disclosure, the porous support PM may include at least one pore PR therein. At least a portion of the pore PR may be filled with a particle of silicon SNP.

The pore PR of the porous support PM may include a micro-pore. The pore PR of the porous support PM may further include one or more selected from a meso-pore and a macro-pore. A volume that the micro-pores occupy in the porous support PM may range from about 50% to about 98%, from about 60% to about 95%, or from about 70% to about 95% of a total pore volume. If (e.g., when) the volume fraction of the micro-pores in the total pore volume falls within the range above, a particle size of silicon may be suitably or appropriately adjusted, and excellent ionic conductivity and electrical conductivity may be achieved.

In this description, the micro-pore may indicate a pore whose diameter is equal to or less than about 2 n, the meso-pore may denote a pore whose diameter is about 2 nm to about 50 nm, and the macro-pore may signify a pore whose diameter is equal to or greater than about 50 nm.

In some embodiments of the present disclosure, the porous support PM may have a specific surface area (BET), which is not filled with the silicon SNP, of about 1 m²/g to about 2,000 m²/g, about 300 m²/g to about 1,800 m²/g, or about 500 m²/g to about 1,500 m²/g.

In some embodiments of the present disclosure, pore diameters and a specific surface area may be measured using a Barrett-Joyner-Halenda (BJH) method and/or calculated utilizing a non-linear density functional theory (NLDFT) method through N₂ adsorption/desorption isotherm. For example, the porous support PM may undergo a pre-treatment process where the porous support PM is heated at a rate of 10 K/min up to 523 K and then maintained at this temperature for 2 to 10 hours under a pressure of 100 mmHg or less, and in liquid nitrogen at a relative pressure (P/P0) controlled below 0.01 Torr, nitrogen may be adsorbed at 10 g/cm³ STP unit points from a relative pressure below 0.01 Torr up to a relative pressure of 0.01 Torr and then adsorbed again at 32 points up to 0.955 Torr. After that, nitrogen desorption may be performed at 24 points up to a relative pressure of 0.14 Torr to measure the pore diameter and the specific surface area. Micro-pore diameters and a specific surface area may be measured within a range where nitrogen is adsorbed at 10 g/cm³ STP unit points from a relative pressure (P/P0) below 0.01 Torr up to a relative pressure of 0.01 Torr, meso-pore diameters may be measured from a range where excessive nitrogen (N₂) is adsorbed, starting from a relative pressure of 0.01 Torr and more, and a specific surface area may be calculated from an N₂ amount measured using the method with respect to the volume of the porous support PM.

An average particle diameter (D₅₀) of the porous support PM may range from about 1 μm to about 50 μm, from about 1 μm to about 30 μm, or from about 5 μm to about 30 μm. The average particle diameter may be a median diameter measured with a laser-type particle size distribution analyzer. If (e.g., when) the average particle diameter of the porous support PM falls within the range above, the negative electrode active material AAM may exhibit excellent lithium ionic conductivity and superior electrical conductivity.

Referring back to FIG. 6, the silicon SNP may fill at least a portion of the pore PR in the porous support PM. For example, the silicon SNP may fill only a portion of the pore PR in the porous support PM or may substantially completely fill the pore PR. In embodiments, the silicon SNP may also be formed on a surface of the porous support PM. A vapor deposition method may be employed to form the silicon SNP on the porous support PM. The vapor deposition method will be further discussed in more detail in connection with a method of manufacturing a negative electrode for an all-solid-state battery. In an embodiment, the silicon SNP formed on the porous support PM may have a nano-particle shape, and may be elemental silicon.

The silicon SNP may be present in an amount of about 20 wt % to about 80 wt % or about 30 wt % to about 70 wt % relative to the total 100 wt % of the negative electrode active material AAM. If (e.g., when) the amount of the silicon SNP included in the negative electrode active material AAM falls within the range above, it may be possible to achieve improved cycle lifespan characteristics and expansion reduction properties.

The negative electrode active material AAM according to an embodiment, or the porous support PM in which the silicon SNP is formed in at least a portion of the pore PR, may exhibit a Si (101) peak in an XRD spectrum at a 2-theta range between 150 and 350.

Referring back to FIGS. 1 and 5, the negative electrode active material layer 220 may further include a solid electrolyte SE. The solid electrolyte SE may have a particle shape, and an average particle diameter of the solid electrolyte SE may be less than that of the negative electrode active material AAM. If (e.g., when) a size of the solid electrolyte SE is less than that of the negative electrode active material AAM, the solid electrolyte SE may be dispersed between the negative electrode active material AAM to reduce a porosity of the negative electrode active material layer 220.

The solid electrolyte SE may include a sulfide-based solid electrolyte having excellent lithium ionic conductivity. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one selected from Ge, Zn, and Ga), Li₂S—GeS₂, Li₂S—SiS₂—Li₃PO₄, Li₂S—SiS₂-LiₚMO_{q} (where p and q are each a positive integer, and “M” is one selected from P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one selected from Li₆PS₅Cl, Li₆PS₅Br, and Li₆PS₅I.

In embodiments, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (AI), gallium (Ga), indium (In), thallium (Tl), silicon (Si), germanium (Ge), tin (Sn), lead (Pb), arsenic (As), antimony (Sb), bismuth (Bi), or a combination thereof.

The solid electrolyte SE included in the negative electrode active material layer 220 may have a medium-sized average particle diameter (D₅₀) less than that of the solid electrolyte included in the solid electrolyte layer 300. For example, the medium-sized average particle diameter (D₅₀) of the solid electrolyte SE in the negative electrode active material layer 220 may be about equal to or less than about 90%, 80%, 70%, 60%, 50%, 40%, 30%, or 20% of the medium-sized average particle diameter (D₅₀) of the solid electrolyte included in the solid electrolyte layer 300. The medium-sized average particle diameter (D₅₀) may be a median diameter measured with a laser-type particle size distribution analyzer.

The negative electrode active material layer 220 may further include a conductive material (e.g., an electrically conductive material). The conductive material may have conductivity (e.g., electrical conductivity) without causing a chemical change (e.g., an undesirable chemical change) of the all-solid-state battery 10 to increase conductivity (e.g., electrical conductivity) of the negative electrode active material AAM and the solid electrolyte SE.

The conductive material may include a carbon-based material. The conductive material may include, for example, one or more selected from graphite, carbon black, acetylene black, carbon nano-fiber, and carbon nano-tube. However, as the negative electrode active material AAM according to embodiments the present disclosure includes the porous support PM having excellent electrical conductivity, no conductive material may be separately included (e.g., the negative electrode may be free or substantially free of graphite, carbon black, acetylene black, carbon nano-fiber, and/or carbon nano-tube, where “substantially free” means that the recited component is present, if at all, only as an incidental impurity).

The negative electrode active material layer 220 may further include a binder. The binder may include a material that adheres to each other the negative electrode active material AAM, the solid electrolyte SE, and the conductive material included in the negative electrode active material layer 220 and that improves adhesion between the negative electrode active material layer 220 and the negative electrode current collector 210. The binder may include, for example, at least one selected from polyvinylidenefluoride, styrene-butadiene rubber (SBR), polytetrafluoroethylene, vinylidenefluoride/hexafluoropropylene copolymer, polyvinylidenefluoride/hexafluoropropylene copolymer, polyacrylonitrile, and polymethyl methacrylate.

Based on the total 100 parts by weight of the negative electrode active material AAM, the solid electrolyte SE, the conductive material, and the binder, the negative electrode active material AAM may be included in an amount of about 60 parts by weight to about 99 parts by weight in the negative electrode active material layer 220. Based on the total 100 parts by weight of the negative electrode active material AAM, the solid electrolyte SE, the conductive material, and the binder, the solid electrolyte SE may be included in an amount of about 0.1 parts by weight to about 40 parts by weight in the negative electrode active material layer 220. If (e.g., when) the amount of each of the negative electrode active material AAM and the solid electrolyte SE falls within the range above, a negative electrode for an all-solid-state battery may have excellent capacity characteristics and superior conductivity (e.g., electrical conductivity).

The following will describe in more detail a method of manufacturing a negative electrode for an all-solid-state battery according to an embodiment of the present disclosure.

A method of manufacturing a negative electrode for an all-solid-state battery according to an embodiment of the present disclosure may include preparing a negative electrode active material, mixing the negative electrode active material and a solid electrolyte with each other to prepare a negative electrode active material slurry, and coating the negative electrode active material slurry on a negative electrode current collector. The preparation of the negative electrode active material may include preparing a porous support, and performing a vapor deposition process on the porous support to form a silicon nano-particle.

The preparation of the porous support may include forming porous hard carbon. There is no particular limitation on a method of forming the porous hard carbon, and any suitable method utilized in the art may be utilized. The formation of the porous hard carbon may include, for example, performing a heat treatment on a carbon source, activating the thermally treated carbon source, and performing a crushing process.

The carbon source may include coal-based pitch, petroleum-based pitch, petroleum-based coke, coal-based coke, polyvinyl chloride, mesophase pitch, tar, low-molecular-weight heavy oil, polyvinyl alcohol resin, furfuryl alcohol resin, triton, citric acid, stearic acid, sucrose, polyvinylidene fluoride, carboxymethyl cellulose, hydroxypropyl cellulose, regenerated cellulose, polyvinylpyrrolidone, polyethylene, polypropylene, ethylene-propylene-diene monomer (EPDM), polyacrylic acid, sodium polyacrylate, polyacrylonitrile, glucose, gelatin, saccharides, phenolic resin, naphthalene resin, polyamide resin, furan resin, polyimide resin, cellulose resin, styrene resin, epoxy resin, vinyl chloride resin, or a combination thereof.

In an embodiment, the heat treatment may be performed under an atmosphere of oxidizing gas, inert gas, or mixed gas thereof. The oxidizing gas may include oxygen, ozone, or a combination thereof, the inert gas may include nitrogen, helium, neon, argon, or a combination thereof, and the mixed gas may include air, but the present disclosure is not limited thereto. For example, the heat treatment may be performed at a temperature of about 100 to 1,000° C. for about 1 to 10 hours.

In an embodiment, the activation of carbon may be performed under an atmosphere of oxidizing gas. The oxidizing as atmosphere may be a water vapor atmosphere, but the present disclosure is not particularly limited thereto. An activation temperature may range from about 500° C. to about 1,000° C., and the activation may be performed under a pressure of about 0.1 to 10 bars for about 0.5 to 10 hours.

The crushing process may be executed before or after the activation process. The crushing process is not particularly limited, and for example, may be performed using a ball mill. A size of the porous support may be adjusted to a suitable or desired dimension through the crushing process.

A vapor deposition process may be performed on the prepared porous support to form silicon nano-particles. The vapor deposition process may include a chemical vapor deposition (CVD) process. A raw material of silicon nano-particles may include SiH₄ gas, Si₂H₆ gas, Si₃H₈ gas, SiCl₄ gas, or a combination thereof.

The vapor deposition process may be performed at a temperature, at which silicon becomes amorphous silicon (a-Si), for example, in a range of about 400° C. to about 700° C. If (e.g., when) the temperature of the vapor deposition process is greater than about 700° C., the deposited silicon may become crystalline to increase an increase in volume expansion during charge and discharge and to degrade cycle lifespan characteristics, which is inappropriate or unsuitable. If (e.g., when) the temperature of the vapor deposition process is less than about 400° C., the silicon raw material may not be efficiently decomposed to possibly act as an impurity remaining on the porous support, which is undesirable.

In the vapor deposition process, a flow rate of the gas as the silicon raw material may range from about 0.3 L/min to about 1 L/min or from about 0.3 L/min to about 0.6 L/min. Through the processes above, a pore of the porous support may be filled with silicon.

The deposition time may range from about 0.5 hours to about 5 hours or from about 0.5 hours to about 3 hours. The vapor deposition time and flow rate may be adjusted in accordance with porosity of the porous support to deposit a suitable or desired amount of silicon nano-particles.

Embodiments of the present disclosure will be discussed below in more detail through embodiments. These embodiments, however, are provided to illustrate examples of the present disclosure, and the scope of the present disclosure is not limited to these embodiments.

### Embodiment

### Manufacture of Negative Electrode

### (1) Preparation of Negative Electrode Active Material

A porous carbon support (commercially available from IOPsilion Co.) underwent a chemical vapor deposition process performed at 400° C. using SiH₄ gas at a flow rate of 0.5 L/min to fill pores of the porous carbon support with silicon. At this stage, an amount of SiH₄ gas was controlled such that a weight ratio of the porous carbon support and the silicon was 55:45.

A negative electrode active material, or the porous carbon support containing deposited silicon, had an average particle diameter (D₅₀) of about 10 μm.

### (2) Manufacture of Negative Electrode Layer

The negative electrode active material, a sulfide-based solid electrolyte (Li₆PS₅Cl), an acrylate-based polymer binder, and a single-walled carbon nano-tube were mixed in a weight ratio of 85:11.5:3:0.5 to prepare a negative electrode active material slurry. The prepared slurry was coated on a stainless steel foil, and then dried and pressed to manufacture a negative electrode layer.

### Fabrication of All-Solid-State Battery

### (1) Manufacture of Positive Electrode Layer

A powder of LiNi_{0.9}Co_{0.05}Mn_{0.05}O₂ (NCM) was prepared as a positive electrode active material. A crystalline argyrodite-type solid electrolyte (Li₆PS₅Cl) was prepared as a solid electrolyte. A butyl acrylate-based binder was prepared, and a single-walled carbon nano-tube conductive material was prepared. The positive electrode active material, the solid electrolyte, the conductive material, and the binder were mixed in a weight ratio of 85.0:13.44:0.56:1.0, and the mixture was formed into a positive electrode sheet. The positive electrode active material layer composition was coated on an aluminum current collector, and dried to manufacture a positive electrode layer including a positive electrode active material layer of about 200 μm in thickness.

### (2) Manufacture of Solid Electrolyte Layer

An argyrodite-type solid electrolyte, Li₆PS₅Cl, was added to an isobutylyl isobutylate binder solution containing an acrylate-based polymer to prepare a solid electrolyte solution (solid content: 50 wt %, mixing ratio of solid electrolyte and binder: 98.7:1.3 by weight).

The solid electrolyte solution was coated on a release polytetrafluoroethylene film, and dried at 60° C. for 2 hours to manufacture a solid electrolyte layer of 100 μm in thickness.

### (3) Fabrication of All-Solid-State Battery

The negative electrode layer, the solid electrolyte layer, and the positive electrode layer were sequentially stacked. The stack was sealed in a pouch form and subject to a high temperature of 80° C. under a pressure of 500 MPa for 30 minutes using a warm isostatic press (WIP) to fabricate an all-solid-state battery.

### Comparative 1

### Preparation of Negative Electrode Active Material

A negative electrode layer was manufactured according to substantially the same method as in the Embodiment, except that, as the negative electrode active material, the porous support containing silicon nano-particles formed therein was replaced with a mixture of silicon particles and carbon. The negative electrode active material in the form of a mixture of silicon and carbon was prepared as follows.

Micro-sized silicon particles (average particle diameter of 1 to 5 μm) were ball-milled to prepare a silicon precursor with a size of 85 nm to 100 nm. The silicon precursor, stearic acid, and ethanol were mixed in a weight ratio of 9:1:110 to prepare a dispersion solution. A spray dryer was used such that the dispersion solution was spray derived at a temperature of 120° C.

The spray-dried product and meso-carbon pitch were mixed in a weight ratio of 55:20, and the mixture was thermally treated at a temperature of 800° C. to 1,000° C. under N₂ atmosphere to form an amorphous carbon-silicon composite.

### Manufacture of Negative Electrode Layer

The negative electrode active material, a sulfide-based solid electrolyte (Li₆PS₅Cl), an acrylate-based polymer binder, and a single-walled carbon nano-tube were mixed in a weight ratio of 85:11.5:3:0.5 to prepare a negative electrode active material slurry. The prepared slurry was coated on a stainless steel foil, and then dried and pressed to manufacture a negative electrode layer.

### Fabrication of All-Solid-State Battery

An all-solid-state battery was fabricated according to substantially the same method as in the Embodiment.

### Comparative 2

### Preparation of Negative Electrode Active Material

A negative electrode active material was prepared according to substantially the same method as in the Embodiment.

### Manufacture of Negative Electrode Layer

The negative electrode active material, a polyvinyl alcohol binder, and a single-walled carbon nano-tube were mixed in a weight ratio of 90:9:1 to prepare a negative electrode active material slurry. The prepared slurry was coated on a stainless steel foil, and then dried and pressed to manufacture a negative electrode layer.

### Fabrication of All-Solid-State Battery

An all-solid-state battery was fabricated according to substantially the same method as in the Embodiment.

### Evaluation 1: X-ray Diffraction Analysis of Negative Electrode Active Material

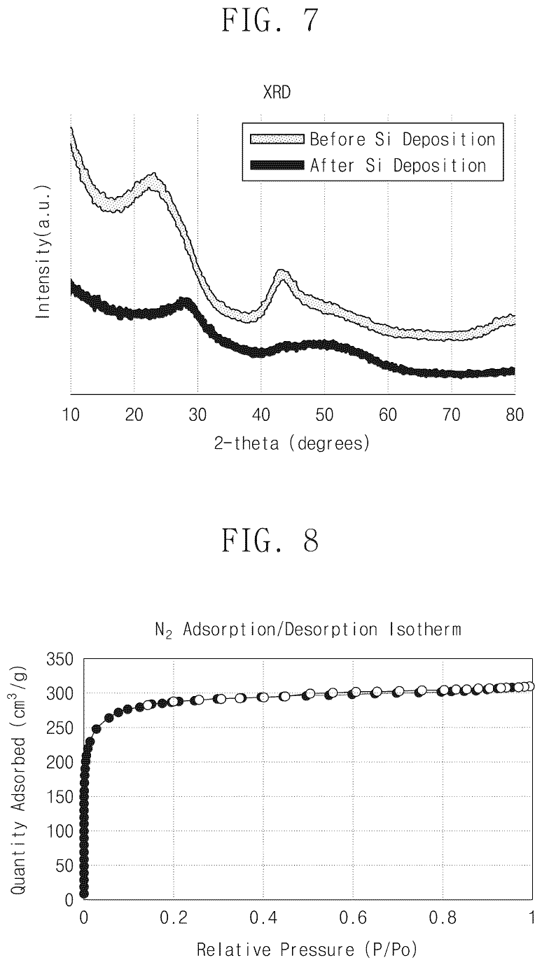

An X-ray diffraction analysis (XRD) was performed on the porous carbon support manufactured in the Embodiment and a porous carbon support in which silicon was vapor deposited, and the results were shown in FIG. 7. Referring to FIG. 7, it may be observed that, in an XRD spectrum based on 2-theta of a porous carbon support in which silicon was not deposited, a carbon (002) peak centered around 24° appears in a range of 20° to 27°. Referring still to FIG. 7, it may be observed that, in an XRD spectrum based on 2-theta of a porous carbon support after silicon was deposited, it may be observed that a silicon (101) peak centered around 28° appears in a range of 15° to 35°. Therefore, it may be ascertained that silicon was deposited and present within the porous support.

### Evaluation 2: Porosity of Negative Electrode Active Material

Pore diameters and a specific surface area may be measured using a Barrett-Joyner-Halenda (BJH) method and/or calculated utilizing a non-linear density functional theory (NLDFT) method through N₂ adsorption/desorption isotherm. For example, the porous support may undergo a pre-treatment process where the porous support is heated at a rate of 10 K/min up to 523 K and then maintained at this temperature for 2 to 10 hours under a pressure of 100 mmHg or less, and in liquid nitrogen at a relative pressure (P/P0) controlled below 0.01 Torr, nitrogen may be adsorbed at 10 g/cm³ STP unit points from a relative pressure below 0.01 Torr up to a relative pressure of 0.01 Torr and then adsorbed again at 32 points up to 0.955 Torr. After that, nitrogen desorption may be performed at 24 points up to a relative pressure of 0.14 Torr to measure the pore diameters and the specific surface area.

Micro-pore diameters and a specific surface area may be measured within a range where nitrogen is adsorbed at 10 g/cm³ STP unit points from a relative pressure (P/P0) below 0.01 Torr up to a relative pressure of 0.01 Torr, meso-pore diameters may be measured from a range where excessive nitrogen (N₂) is adsorbed, starting from a relative pressure of 0.01 Torr and more, and a specific surface area may be calculated from an N₂ amount measured using the method with respect to the volume of the porous support.

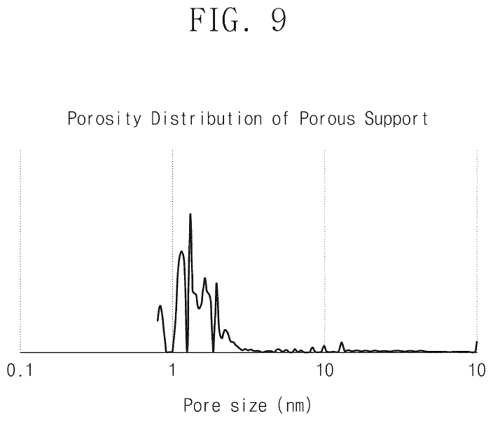

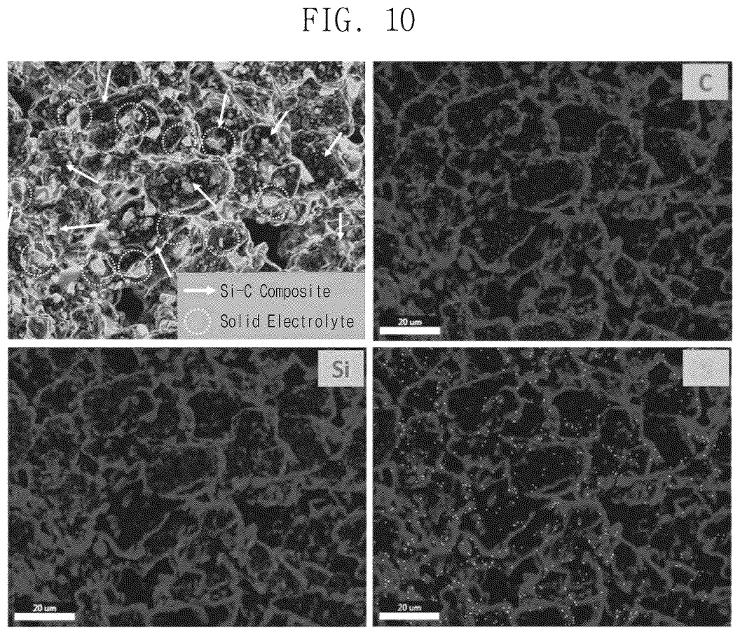

The measured specific surface area of the porous support was 1,450 m²/g, and a nitrogen adsorption/desorption isotherm and a porous distribution of the carbon support are shown in FIGS. 8 and 9, respectively.

Referring to FIG. 8, it may be observed that a large amount of nitrogen is adsorbed due to the presence of numerous pores in the porous carbon support. Referring to FIG. 9, it may be observed that the porous carbon support contains a high concentration of nano-pores having a pore size of 2 nm or less.

### Evaluation 3: Cross-Section of Electrode Plate

FIG. 10 is an SEM image and an EDX mapping image of the negative electrode manufactured in Embodiment. Referring to FIG. 10, it may be observed that silicon is evenly distributed within the porous support, as a negative electrode active material, and that a solid electrolyte containing sulfur is uniformly present on a surface of the negative electrode active material.

Evaluation 4: Rate Charge Characteristics of all-Solid-State Battery

For the all-solid-state batteries fabricated in the example and the comparative examples, a cycle was conducted by charging to an upper limit voltage of 4.25 V at a constant current at 25° C. and then discharging to a cut-off voltage of 2.5 V at a constant current of 0.33 C. The charge current was changed to 0.33 C, 0.5 C, 1 C, and 2 C, and a charge rate for each case was evaluated and listed in Table 1.

TABLE 1

| | Negative electrode | | | | |
|---|---|---|---|---|---|
| | active material:Solid | | | | |
| | electrolyte:Conductive | 0.33 | 0.5 | 1 | 2 |
| Charge rate | material:Binder | C | C | C | C |
| Embodiment | 85:11.5:3:0.5 | 136 | 117 | 109 | 85 |
| Comparative 1 | 85:11.5:3:0.5 | 121 | 84 | 68 | 44 |
| Comparative 2 | 90:0:9:1 | 95 | 72 | 57 | 39 |

Referring to Table 1, it may be observed that, compared to Comparatives 1 and 2, the Embodiment has a high charge rate at all C rates.

### Evaluation 5: Rate Discharge of All-Solid-State Battery

For the rechargeable lithium batteries fabricated in the Embodiment and Comparatives 1 and 2, a cycle was conducted by charging to an upper limit voltage of 4.25 V at a constant current of 0.33 C at 25° C. and then discharging to a cut-off voltage of 2.5 V at a constant current. The discharge current was changed to 0.33 C, 0.5 C, 1 C, and 2 C, and a discharge rate for each case was evaluated and listed in Table 2.

TABLE 2

| | Negative | | | | |
|---|---|---|---|---|---|
| | electrode active | | | | |
| | material:Solid elec- | 0.33 C | 0.5 C | 1 C | 2 C |
| Discharge | trolyte:Binder:Con- | (mAh/ | (mAh/ | (mAh/ | (mAh/ |
| rate | ductive material | g) | g) | g) | g) |
| Embodiment | 85:11.5:3:0.5 | 134 | 112 | 87 | 65 |
| Compar- | 85:11.5:3:0.5 | 118 | 79 | 51 | 32 |
| ative 1 | | | | | |
| Compar- | 90:0:9:1 | 93 | 67 | 41 | 26 |
| ative 2 | | | | | |

Referring to Table 2, it may be observed that, compared to Comparatives 1 and 2, the Embodiment has an excellent discharge rate at all C rates.

### Evaluation 6: Variation in Thickness of All-Solid-State Battery

After 25 cycles of discharge and charge, thicknesses of the all-solid-state batteries fabricated according to the Embodiment and Comparatives 1 and 2 after charge and discharge were measured, and the results were listed in Table 3. The thickness of the battery was measured using a jig (model: EQ-PTC-TEM) commercially available from MTI Corporation.

TABLE 3

| | | Expansion | Expansion |
|---|---|---|---|
| | | rate of | rate of |
| | Negative electrode | thickness | thickness |
| | active material:Solid | during | during |
| | electrolyte:Binder:Con- | discharge | charge |
| | ductive material | (%) | (%) |
| Embodiment | 85:11.5:3:0.5 | 9.2 | 12.6 |
| Comparative 1 | 85:11.5:3:0.5 | 10.5 | 14.3 |
| Comparative 2 | 90:0:9:1 | 14.6 | 18.9 |

Referring to Table 3, it may be observed that the thickness variation of the all-solid-state battery according to the Embodiment is less than the thickness variation of the all-solid-state batteries according to Comparatives 1 and 2.

A negative electrode for an all-solid-state battery according to embodiments of the present disclosure may include a porous support and silicon that fills at least portions of pores of the porous support, and thus it may be possible to achieve an excellent capacity, lithium ion mobility, and electrical conductivity.

If (e.g., when) using a method of manufacturing a negative electrode for an all-solid-state battery according to embodiments of the present disclosure, it may be possible to manufacture a negative electrode having high lithium ion mobility and electrical conductivity.

While the subject matter of this disclosure has been described in connection with what is presently considered to be example embodiments, it is to be understood that the present disclosure is not limited to the disclosed embodiments and is intended to cover various suitable modifications and equivalent arrangements included within the spirit and scope of the appended claims and equivalents thereof, and therefore the aforementioned embodiments should be understood to be examples but not limiting this disclosure in any way.

What is claimed is:

1. A negative electrode for an all-solid-state battery, the negative electrode comprising:
a negative electrode current collector; and
a negative electrode active material layer,
wherein the negative electrode active material layer comprises a negative electrode active material and a solid electrolyte,
wherein the negative electrode active material comprises a porous support and silicon (Si), and
wherein the silicon fills at least a portion of a pore of the porous support.

2. The negative electrode as claimed in claim 1, wherein the porous support comprises amorphous hard carbon, and
wherein the amorphous hard carbon shows a peak at about 20° to about 26° in an XRD spectrum based on 2-theta.

3. The negative electrode as claimed in claim 1, wherein an average particle diameter (D₅₀) of the porous support is in a range of about 1 μm to about 50 μm.

4. The negative electrode as claimed in claim 1, wherein the pore of the porous support comprises a micro-pore, and
wherein a volume occupied by the micro-pore is about 50% to about 98% of a total volume of the pore.

5. The negative electrode as claimed in claim 1, wherein a specific surface area of the porous support is in a range of about 500 m²/g to about 1,500 m²/g.

6. The negative electrode as claimed in claim 1, wherein the silicon is present in an amount of about 20 parts by weight to about 80 parts by weight relative to 100 parts by weight of the negative electrode active material.

7. The negative electrode as claimed in claim 1, wherein the silicon is formed on the porous support by vapor deposition.

8. The negative electrode as claimed in claim 1, wherein the negative electrode active material is present in an amount of about 60 parts by weight to about 99 parts by weight relative to 100 parts by weight of the negative electrode active material layer.

9. The negative electrode as claimed in claim 1, wherein the negative electrode active material layer further comprises a binder.

10. The negative electrode as claimed in claim 1, wherein:
the solid electrolyte comprises a sulfide-based solid electrolyte, and
an average particle diameter of the negative electrode active material is greater than an average particle diameter of the solid electrolyte.

11. An all-solid-state battery, comprising:
the negative electrode as claimed in claim 1;
a positive electrode; and
a solid electrolyte layer between the negative electrode and the positive electrode.

12. The all-solid-state battery as claimed in claim 11, wherein:
the all-solid-state battery in a discharged state has a first height,
the all-solid-state battery in a charged state has a second height, and
a ratio of the second height to the first height is in a range of about 1.1 to about 1.5.

13. The all-solid-state battery as claimed in claim 11, wherein the positive electrode comprises a positive electrode active material and a solid electrolyte.

14. The all-solid-state battery as claimed in claim 11, wherein the solid electrolyte layer comprises a sulfide-based solid electrolyte.

15. A method of manufacturing a negative electrode for an all-solid-state battery, the method comprising:
preparing a negative electrode active material;
mixing the negative electrode active material and a solid electrolyte to prepare a negative electrode active material slurry; and
coating the negative electrode active material slurry on a negative electrode current collector,
wherein preparing the negative electrode active material comprises:
preparing a porous support; and
allowing the porous support to undergo a vapor deposition process to form a silicon nano-particle.

16. The method as claimed in claim 15, wherein the vapor deposition process is performed at a temperature of about 400° C. to about 700° C.

17. The method as claimed in claim 15, wherein the porous support comprises amorphous hard carbon,
wherein the amorphous hard carbon shows a peak at about 20° to about 26° in an XRD spectrum based on 2-theta.

18. The method as claimed in claim 15, wherein an average particle diameter (D₅₀) of the porous support is in a range of about 1 μm to about 50 μm.
